(19) United States
(12) Patent Application Publication
(10) Pub. No.: US 2025/0080431 A1
(43) Pub. Date: Mar. 6, 2025

(54) DATA MODELING TECHNIQUES FOR PROVIDING ENVIRONMENTAL IMPACT DATA

(71) Applicant: WELLS FARGO BANK, N.A., San Francisco, CA (US)

(72) Inventors: Joel Boeder, Maple Grove, MN (US); Laurie Harrison, Davidson, NC (US); Eric J. Miller, Minneapolis, MN (US); Stephanie Rico, Rodeo, CA (US); Richard Orlando Toohey, Burlington, VT (US); Young M. Yang, San Francisco, CA (US); Ramesh Yarlagadda, Charlotte, NC (US)

(21) Appl. No.: 17/810,099

(22) Filed: Jun. 30, 2022

(51) Int. Cl. H04L 41/22

(52) U.S. Cl. CPC H04L 41/22

(57) ABSTRACT

An environmental impact computing system receives event data that describes an activity-source combination, such as an activity performed by a person associated with a user account, or a source that is associated with the activity that is performed. The environmental impact computing system includes a supplier impact model which calculates an environmental impact factor of the activity-source combination, and a user impact model which calculates a user-specific modifier. Based on the user-specific modifier, the environmental impact computing system adjusts the environmental impact factor. The environmental impact computing system modifies a user interface display, such as a user device that is associated with the user account, to display the adjusted environmental impact factor. In some embodiments, the user interface display is modified to display additional data, such as data describing a projected cumulative environmental impact.

### TECHNICAL FIELD

This disclosure relates generally to the field of environmental impact data, and more specifically relates to modeling environmental impact data.

### BACKGROUND

Reducing consumption of environmental resources is increasing in importance, at both an individual and organizational level. Individuals desire information about practical ways to reduce their personal environmental impact (e.g., “footprint”). However, data describing environmental impact for activities is often inconsistent, difficult to understand, or unavailable to individuals. A person who desires to reduce individual environmental impact may be unable to find or interpret information that accurately describes resources involved in an activity performed by the person. In addition, contemporary techniques to provide information about environmental impact may fail to incorporate information about a person's characteristics, such as a contemporary database that provides “average gasoline consumption” while disregarding a person's preference for walking instead of driving.

It is desirable to develop technical tools that can accurately provide information about environmental impact that is adjusted for a user. In addition, it is desirable for technical tools to provide accurate and relevant information via an understandable and easily accessed user interface, which can assist individuals in reducing their own environmental impact.

### SUMMARY

According to certain embodiments, an environmental impact computing system receives event data that is associated with at least one user account. The event data describes an activity-source combination, such as an activity performed by a person associated with the user account, or a source that provides (or otherwise is associated with) the activity that is performed. The environmental impact computing system calculates an environmental impact factor that is associated with the activity-source combination. The environmental impact factor is calculated via a supplier impact model. The environmental impact computing system calculates a user-specific modifier. The user-specific modifier is calculated via a user impact model. Based on the user-specific modifier, the environmental impact computing system adjusts the environmental impact factor. The environmental impact computing system modifies a user interface display to display the adjusted environmental impact factor. In some embodiments, the user interface display is modified on a user device that is associated with the user account.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram depicting an example of computing environment in which an environmental impact system provides user-adjusted environmental impact data to a user device, according to certain embodiments;

FIG. 2 is a diagram depicting an example of a computing environment in which an environmental impact system generates user-adjusted environmental impact data based on a combination of data outputs from multiple computer-implemented models, according to certain embodiments;

FIG. 3 is a flow chart depicting an example of a process for providing a user-adjusted environmental impact factor based on a combination of data outputs from multiple computer-implemented models, according to certain embodiments;

FIG. 4 is a diagram depicting an example of a computing environment in which an environmental impact system identifies an event characteristic that modifies an impact of the event, according to certain embodiments; and

FIG. 5 is a block diagram depicting an example of an environmental impact computing system for implementing one or more described techniques, according to certain embodiments.

### DETAILED DESCRIPTION

As discussed above, prior techniques for providing environmental impact information include data collections that can be inconsistent, difficult to understand, or unavailable to individuals. Environmental impact data, if available, is often presented in extensive tables of numeric entries, which may utilize specialized notation. In some cases, extensive tabulated data or specialized notation can be difficult for individuals to interpret without training, for example, in a particular profession, such as environmental engineering.

In some cases, contemporary tools for providing individual environmental impact information may fail to incorporate user-specific information, and may be inaccurate for individuals using the contemporary tool. In addition, contemporary interfaces for presenting environmental impact data may fail to provide contextual information about the environmental impact data. For example, a contemporary interface may provide tabulated data describing resource usage related to a particular product. However, the example contemporary interface may fail to provide understandable information about an impact context for the particular product, such as usage of the product over time or other types of impact that a particular product might have.

Certain embodiments described herein provide techniques to generate user-adjusted environmental impact data, such as via a user interface of a user device. An environmental impact system can generate the user-adjusted environmental impact data based on combinations of output from multiple computer-implemented models. For example, the environmental impact system could identify a combination of an activity and a source of the activity, such as an activity of purchasing a meal and a source of a restaurant that prepared the meal. The environmental impact system could identify the activity-source combination based on event data that is associated with a particular user account. In addition, the environmental impact system can calculate the user-adjusted environmental impact data that describes an impact of the activity-source combination in the context of the particular user account. For example, the environmental impact system includes a supplier impact model that is configured to calculate an environmental impact of the activity-source combination, such as by calculating an impact of resources, a supply chain, or other actions involved in the activity. In addition, the environmental impact system could include a user impact model that is configured to calculate a user-specific modifier correlated to the particular user account. As an example, if the user impact model receives data indicating that a person associated with the user account prefers vegetarian meals, the user-specific modifier could indicate an adjusted environmental impact, such as an adjustment that describes a reduced environmental impact of plant-based meals.

The following examples are provided to introduce certain embodiments of the present disclosure. In the example implementation, an environmental impact system receives event data associated with a user account. The event data describes, for example, an event associated with the user account, such as a purchase transaction. The environmental impact system determines at least one activity-source combination described by the event data, such as a purchase action performed at a business that provides an item (e.g., product, service, donation) that is purchased. A supplier impact model included in the environmental impact system determines an environmental impact factor associated with the activity-source combination. For example, the supplier impact model could determine resources involved in producing the activity, a supply chain utilized by the source, or additional elements that contribute to an environmental impact of the activity-source combination. In addition, a user impact model included in the environmental impact system determines a user-specific modifier associated with the user account. The user impact model calculates the user-specific modifier based on, for example, one or more impact context factors. The impact context factors describe characteristics associated with the user account, such as characteristics of a user device or a person associated with the user account. Based on a combination of the environmental impact factor and the user-specific modifier, the environmental impact system determines an adjustment to the environmental impact factor. The adjusted environmental impact factor indicates a user-adjusted environmental impact for the activity-source combination from the event data. In addition, the environmental impact system provides the adjusted environmental impact factor to a user device, such as a user device associated with the user account. Responsive to the adjusted environmental impact factor, the user device updates a user interface to indicate the user-adjusted environmental impact associated with the activity-source combination. In some cases, the user device updates the user interface to indicate additional information, such as a threshold value or a cumulative value for environmental impact associated with the user account.

Certain embodiments described herein provide improved techniques for providing accurate data describing environmental impact at an individual level. For example, an environmental impact system can utilize particular rules to combine data outputs of multiple computer-implemented models to calculate user-adjusted environmental impact data. In addition, the environmental impact system can utilize particular rules to calculate multiple output variations from the multiple computer-implemented models to calculate alternative user-adjusted environmental impact data. The utilization of the particular rules can generate new or additional data objects—e.g., the user-adjusted environmental impact data, alternative user-adjusted environmental impact data—that describe environmental impact with increased accuracy, such as for an individual. In addition, a user device that receives the generated data objects can modify a user interface to indicate the environmental impact with increased accuracy. In some cases, an environmental impact system that uses techniques described herein can provide an individual, such as a person who utilizes the example user device, with high-accuracy data describing the individual's environmental impact. In some cases, the environmental impact system using techniques described herein can provide the individual with alternative user-adjusted environmental impact data describing activities that can lower the individual's environmental impact further. In some cases, the environmental impact system using techniques described herein can provide the individual with real-time data describing environmental impacts calculated by additional user devices, such as user devices for additional individuals using the environmental impact system to reduce their environmental impacts.

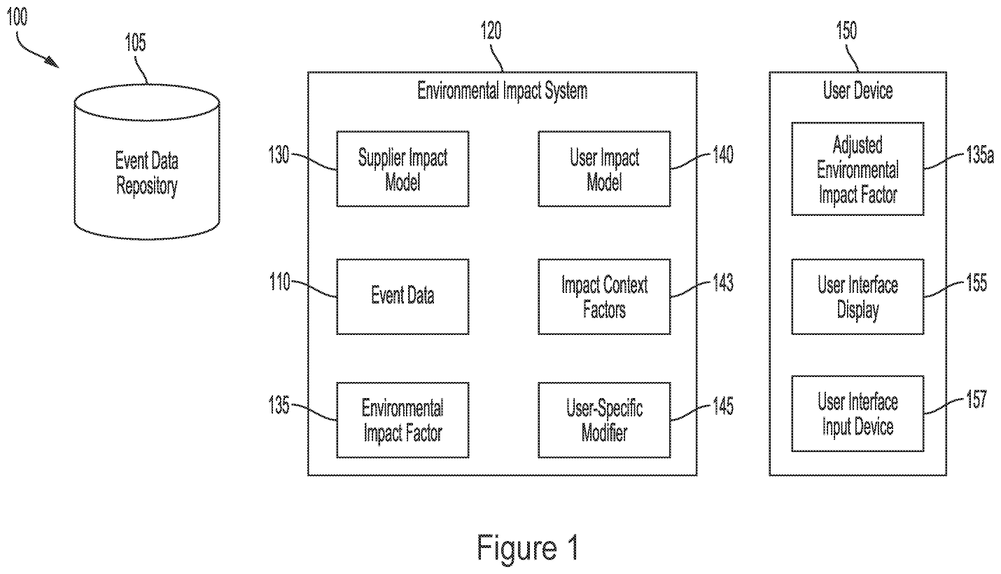

Referring now to the drawings, FIG. 1 is a diagram depicting an example of a computing environment 100, in which an environmental impact system 120 provides user-adjusted environmental impact data to a user device 150. The user device 150 updates a user interface based on the user-adjusted environmental impact data, such as a user interface including one or more of a user interface display 155 or a user interface input device 157. In some cases, the environmental impact system 120 includes multiple computer-implemented models, such as a supplier impact model 130 or a user impact model 140. In addition, the environmental impact system 120 calculates the user-adjusted environmental impact data via the multiple computer-implemented models. For example, the environmental impact system 120 could generate at least one environmental impact factor, such as an environmental impact factor 135 or an adjusted environmental impact factor 135a, based on a combination of data outputs from the supplier impact model 130 and the user impact model 140.

In the computing environment 100, the environmental impact system 120 includes the supplier impact model 130 and the user impact model 140. In some cases, the environmental impact system 120 receives event data 110, such as from an event data repository 105. The event data repository 105 can be included in (or otherwise controlled by) a third-party computing system, such as a third-party system that handles transactions or other activities associated with user accounts. The event data 110 can include data describing an event associated with a particular user account, such as a user account or multiple user accounts for a person who utilizes the user device 150. In FIG. 1, the environmental impact system 120 receives the event data 110 from the repository 105, but other implementations are possible. For example, an environmental impact system could receive event data from a user device, such as a smartphone or another type of user device, that is associated with a user account.

In some implementations, the event data 110 may be associated with one or more user accounts that correspond to various subsets of event data. As an example, the user device 150 could be configured to implement an application, such as an electronic wallet application, that is associated with multiple user accounts via which subsets of the event data 110 could be generated. In this example, the electronic wallet application could be associated with a first user account related to a mass transit pass and a second user account associated with a credit card. In this example, the event data 110 could include a first subset of event data generated via the example mass transit pass and associated with the first user account, and a second subset of event data generated via the example credit card and associated with the second user account. In some cases, the event data 110 may include a subset of event data correlated with a user account that is not associated with the user device 150. As an example, the person who utilizes the user device 150 may have a third user account associated with a home thermostat, such that the person administers the third user account via techniques that do not include the user device 150.

In FIG. 1, the event data 110 includes data describing activities associated with the user device 150, such as activities of the particular user account for the person who utilizes the user device 150. In addition, the event data 110 includes data describing sources of the activities. Examples of activities described by the event data 110 can include product purchases, payment for services, donations to non-profit organizations, actions performed by the person associated with the user account (e.g., walking to work), or other suitable types of activities. Examples of sources described by the event data 110 can include products, businesses, non-profit organizations, geographical locations, the person associated with the user account, or other suitable types of sources. For instance, the event data 110 could describe a merchant or a type of merchant, a product or type of product, a financial amount, a consumption quantity (e.g., gallons of gasoline), or other data describing an activity or a source.

Based on the event data 110, the environmental impact system 120 determines one or more activity-source combinations. The activity-source combinations can be associated with the particular user account for the user device 150. In addition, the environmental impact system 120 calculates environmental impact data based on the one or more activity-source combinations. For example, the event data 110 could describe a transaction that includes purchasing a gallon of milk from a grocery store at a geographical location. Based on this example transaction data, the environmental impact system 120 can identify an activity, such as purchasing the milk, and a source, such as the grocery store at the geographical location. In some cases, the environmental impact system 120 identifies the activity or the source based on one or more collections of data describing activities or sources, such as a merchant category code (“MCC”), a stock-keeping unit (“SKU”) number, or other suitable data collections that describe activities or sources. In some cases, data collections that describe activities or sources may include thousands or hundreds of thousands of data entries, and may be difficult or impossible for a human to interpret. In addition, the environmental impact system 120 could identify the activity or the source based on additional data received from the user device 150. As an example, the environmental impact system 120 could identify a source based on geolocation data provided by the user device 150, such as geolocation data describing a location of a store. As an additional example, the environmental impact system 120 could identify an activity based on descriptive data provided by the user device 150, such as data provided by a nutrition application that describes a meal.

In FIG. 1, the environmental impact system 120 provides the event data 110 or the identified activity-source combinations (or both) as an input to the supplier impact model 130. Based on the input data, the supplier impact model 130 calculates one or more environmental impact factors, such as the environmental impact factor 135. In some cases, the supplier impact model 130 determines one or more allocated resources that are involved in the activity-source combination. In some cases, the supplier impact model 130 could identify resources involved in a supply chain of the activity-source combination. In addition, the supplier impact model 130 calculates the environmental impact factor 135 for the identified resources. The environmental impact factor could include a carbon impact factor (e.g., “carbon footprint”), a water impact factor, or any other suitable type of environmental impact factor. In some cases, the supplier impact model 130 calculates the environmental impact factor 135 based on one or more collections of data describing allocated resources or supply chain involvement for an activity-source combination, such as the North American Industry Classification System (“NAICS”) or other suitable data collections that describe resource allocation or supply chains. In some cases, data collections that describe resource allocation or supply chain involvement may include thousands or hundreds of thousands of data entries, and may be difficult or impossible for a human to interpret.

Continuing with the above example gallon of milk, the supplier impact model 130 could identify resources involved in production of the milk, such as dairy cattle raised for milking, grains that are allocated as cattle feed, electricity for operating milking equipment, or other resources allocated during milk production. In addition, the supplier impact model 130 could identify resources involved in the milk supply chain, such as steel or plastics used to manufacture milking equipment, petroleum resources allocated for transporting milk, or other resources allocated in a supply chain involved with the milk production. In this example, the supplier impact model 130 could calculate the environmental impact factor 135 based on data describing carbon resources involved in the milk production and supply chain.

In some embodiments, the environmental impact system 120 modifies the environmental impact factor 135, such as a modification to generate user-adjusted environmental impact data. For example, the environmental impact system 120 could access one or more impact context factors 143. The impact context factors 143 are associated with, for instance, the particular user account for the user device 150. In some cases, the impact context factors 143 include data describing one or more characteristics of the user device 150 or the person who utilizes the user device 150. In addition, the impact context factors 143 describe characteristics that adjust environmental impact data for one or more activity-source combinations included in the event data 110. Examples of impact context factors could include characteristics of the user device 150 or the person who utilizes the user device 150, such as a geographic location, a preferred transportation type (e.g., walking, transit, a particular car model), a preferred diet (e.g., plant-based, vegan), or other characteristics. In some cases, one or more of the impact context factors 143 are received by the environmental impact system 120 via the user device 150. For example, the user device 150 could provide a particular impact context factor to the environmental impact system 120 responsive to an input entered via a user interface of the user device 150, such as the user interface input device 157. In addition, the environmental impact system 120 could identify one or more of the impact context factors 143 based on additional data received from the user device 150. As an example, the environmental impact system 120 could identify an particular impact context factor for “prefers biking” based on geolocation data provided by the user device 150.

In FIG. 1, the user impact model 140 receives the environmental impact factor 135 as an input. In addition, the user impact model receives one or more of the impact context factors 143 as an input. Based on the input data, the user impact model 140 calculates one or more modifying factors, such as a user-specific modifier 145. The user-specific modifier 145 includes data that describes one or more adjustments to the environmental impact factor 135. In addition, the adjustments are calculated based on the characteristics associated with the particular user account, such as the characteristics of the user device 150 or the person who utilizes the user device 150. For example, if the impact context factors 143 indicate that the user device 150 has a particular geographical location that is relatively close to the grocery store at which the example gallon of milk was purchased, the user-specific modifier 145 may indicate a relatively small adjustment to the environmental impact factor 135. As an alternative example, if the impact context factors 143 indicate that the geographical location of the user device 150 is relatively far from the example grocery store, the user-specific modifier 145 may indicate a relatively large adjustment to the environmental impact factor 135.

In some cases, the environmental impact system 120 adjusts the environmental impact factor 135 based on the user-specific modifier 145. For example, the environmental impact system 120 generates the adjusted environmental impact factor 135a by applying the user-specific modifier 145 to the environmental impact factor 135. The adjusted environmental impact factor can indicate user-adjusted environmental impact data for the activity-source combination in the event data 110, such as environmental impact data that is modified to reflect specific characteristics of the user device 150 or the person who utilizes the user device 150. In addition, the environmental impact system 120 provides the adjusted environmental impact factor 135a to the user device 150. Responsive to the adjusted environmental impact factor 135a, the user device 150 updates the user display device 155. The update may indicate the user-adjusted environmental impact data that describes an impact, such as a carbon impact, of the activity and source represented by the event data 110. In some cases, the person who utilizes the user device 150 may determine, based on the updated user display device 155, that the activity and source improve (e.g., reduce) an environmental impact for the person.

In some implementations, the environmental impact system 120 generates data identifying one or more of the supplier impact model 130, the user impact model 140, or the impact context factors 143. In some cases, the environmental impact system 120 could generate data identifying one or more data collections that describe activities or sources, or data collections resource allocation or supply chain involvement. The environmental impact system 120 may provide to the user device some or all of the data identifying the models 130 or 140, the impact context factors 143, or the data collections. In addition, the user device 150 may update the user display device 155 responsive to the data identifying the models 130 or 140, the impact context factors 143, or the data collections. For example, the update may indicate a data collection used to determine allocated resources or supply chain involvement (e.g., the NAICS data collection) for an activity-source combination that is described by the adjusted environmental impact factor 135a. In addition, the update may indicate one or more characteristics of at least one model or impact context factor via which the adjusted environmental impact factor 135a is calculated, such as the supplier impact model 130 or the user impact model 140. In some cases, the environmental impact system 120 generates data identifying an origin of the event data 110 representing the activity-source combination described by the adjusted environmental impact factor 135a. In addition, the user device 150 may update the user display device 155 responsive to the data identifying the origin of the event data 110, such as an update indicating an electronic wallet as the event data origin for the activity-source combination described by the adjusted environmental impact factor 135a.

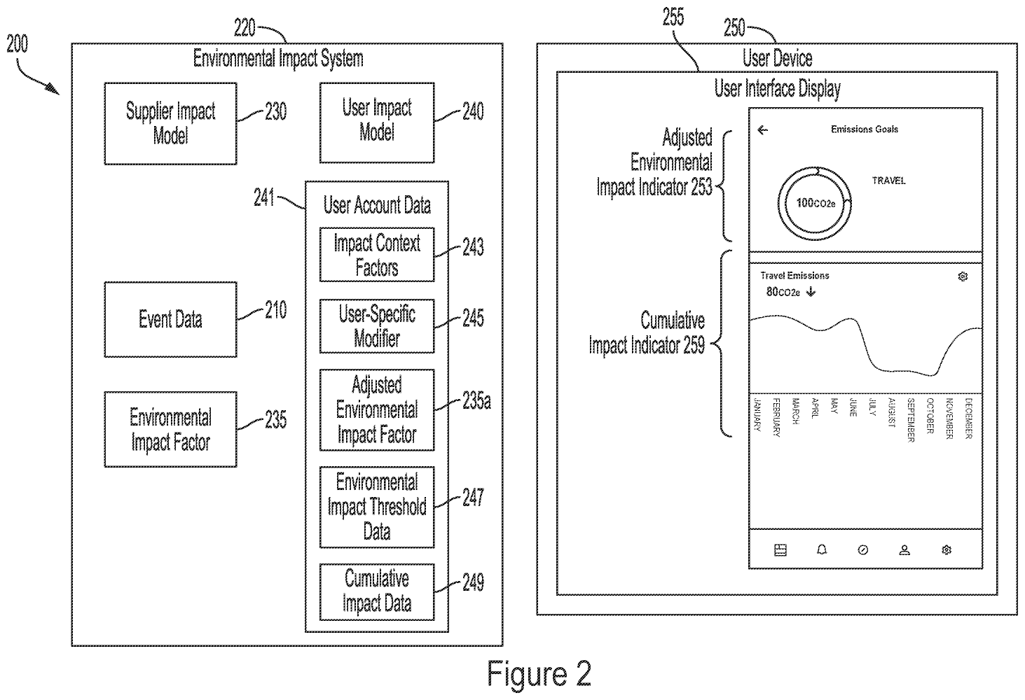

In some cases, an environmental impact system generates data that is configured to modify a user interface, such as a user interface display on a user device. In addition, the data for the user interface indicates a user-adjusted environmental impact factor that is based on a combination of data outputs from multiple computer-implemented models. FIG. 2 is a diagram depicting an example of a computing environment 200 that includes an environmental impact system 220 and a user device 250. The environmental impact system 220 generates, for example, user account data 241. The user account data 241 can include at least one data object that is associated with a user account for the user device 250, such as a user account for a person who utilizes the user device 250. In some cases, the user account data 241 can include one or more data objects that are associated with one or more user accounts for the person who utilizes the user device 250, such as data associated with an electronic wallet application, additional data associated with an electronic thermostat device, and further additional data associated with a further user account (or accounts) for the person. Responsive to receiving the user account data 241 from the environmental impact system 220, the user device 250 could update (or otherwise modify) the user interface display 255 based on one or more portions of the user account data 241.

In the computing environment 200, the environmental impact system 220 includes a supplier impact model 230 and a user impact model 240. In addition, the environmental impact system 220 generates one or more portions of the user account data 241 based on a combination of data outputs from the supplier impact model 230 and the user impact model 240. In some cases, the environmental impact system 220 receives event data 210, such as from a third-party computing system that handles transactions or other activities associated with user accounts, as generally described in regard to FIG. 1. In FIG. 2, the event data 210 includes data describing at least one event that is associated with the user account of the user device 250. Based on the event data 210, the environmental impact system 220 identifies one or more activity-source combinations associated with the user account of the user device 250. As an example, the event data 210 could describe a purchase transaction that is performed via a financial account (e.g., a credit card) associated with the user device 250. In addition, the environmental impact system 220 could determine that the example purchase transaction indicates a combination of an activity and a source, such as purchasing a meal from a restaurant.

In FIG. 2, the environmental impact system 220 generates one or more of an environmental impact factor 235 or an adjusted environmental impact factor 235a. For example, the supplier impact model 230 receives one or more of the event data 210 or the identified activity-source combination. The supplier impact model 230 generates the environmental impact factor 235 by calculating an environmental impact of the activity-source combination, such as a carbon impact calculated based on allocated resources and/or supply chain involvement described by data collections, as generally described in regard to FIG. 1. In addition, the user impact model 240 generates a user-specific modifier 245. For example, the user impact model 240 could receive the environmental impact factor 235 and one or more impact context factors, such as impact context factors 243 included in the user account data 241 (or otherwise associated with the user account of the user device 250). The impact context factors 243 can describe characteristics of the user device 250 or the person who utilizes the user device 250. An example characteristic described by the impact context factors 243 could include a preference for walking to restaurants. The environmental impact system 220 generates the adjusted environmental impact factor 235a based on a combination of the environmental impact factor 235 output by the supplier impact model 230 and the user-specific modifier 245 output by the user impact model 240. In FIG. 2, the factors 235 and 235a are described as indicating a carbon impact, but other types of impact factors are possible. For example, an environmental impact system could generate one or more impact factors describing usage of water resources, humane treatment of animals, utilization of local businesses, or other types of impact factors for activity-source combinations.

In some embodiments, the environmental impact system 220 generates or modifies a portion of the user account data 241 based on data outputs from one or more of the supplier impact model 230 or the user impact model 240. For example, the environmental impact system 220 generates or receives the impact context factors 243, such as an impact context factor based on data received from the user device 250. The environmental impact system 220 can modify the user account data 241 to include the impact context factors 243. In addition, the environmental impact system 220 can modify the user account data 241 to include one or more of the user-specific modifier 245 or the adjusted environmental impact factor 235a. In some cases, the user account data 241 could include the environmental impact factor 235.

In the computing environment 200, the user account data 241 includes environmental impact threshold data 247. In some cases, the environmental impact threshold data 247 indicates a threshold value for the impact type indicated by the factors 235 and 235a, such as a threshold carbon impact for the example carbon impact described in regard to FIG. 2. The environmental impact threshold data 247 indicates, for example, a threshold value that is associated with the user account for the user device 250. For instance, the environmental impact threshold data 247 could indicate a target value that is provided by the user device 250, such as a target value that the user device 250 receives as a user input. In addition, the environmental impact threshold data 247 could indicate a target value that is calculated by the environmental impact system 220 or an additional computing system, such as a target value that is calculated based on historical event data associated with the user account for the user device 250 (or additional user accounts). In some cases, the user impact model 240 (or another component of the environmental impact system 220) calculates a difference between the adjusted environmental impact factor 235a and the environmental impact threshold data 247.

In some embodiments, the user account data 241 includes cumulative impact data 249. In some cases, the cumulative impact data 249 indicates an environmental impact for multiple events that are associated with the user account for the user device 250, or with multiple user accounts for the user device 250. For example, the environmental impact system 220 receives additional event data that describes historical events associated with the user account of the user device 250, such as previous transactions or other activities associated with the user account. In some cases, the additional event data could describe additional account events associated with additional user accounts of the user device 250, such as transactions or other activities associated with multiple user accounts. The multiple user accounts could be associated with, for example, various ones of personal exercise devices (e.g., a walking distance tracker), electronic wallet applications, utilities accounts (e.g., usage of electricity, water, or other utilities), or other suitable types of user accounts. In addition, the environmental impact system 220 could calculate additional environmental impact factors, or adjusted environmental impact factors, describing impacts of one or more of the historical events or the additional account events. The environmental impact system 220 may calculate (or otherwise receive) the cumulative impact data 249 based on a combination of the additional environmental impact factors or adjusted environmental impact factors. In some cases, the cumulative impact data 249 is modified to include one or more of the factors 235 or 235a. For example, the cumulative impact data 249 could indicate a non-user-adjusted environmental impact calculated from the historical events (or additional account events), and also indicate a user-adjusted environmental impact calculated from the historical events (or additional account events). In some cases, the environmental impact system 220 calculates a projected cumulative impact that is associated with the user account for the user device 250. For example, the environmental impact system 220 could calculate (or otherwise receive) an estimated environmental impact that is based on the historical events (or additional account events), such as an extrapolation that is calculated over a period of time. In some cases, the user impact model 240 (or another component of the environmental impact system 220) calculates a difference between the cumulative impact data 249 and the environmental impact threshold data 247.

In some cases, the user account data 241 includes data describing a calculation of one or more of the user-specific modifier 245 or the adjusted environmental impact factor 235a. For example, the environmental impact system 220 generates data identifying one or more characteristics of the supplier impact model 230, the user impact model 240, the impact context factors 243, data collections that describe activities or sources, data collections resource allocation or supply chain involvement, or information utilized in calculating the user-specific modifier 245 or the adjusted environmental impact factor 235a. As an example, if the supplier impact model 230 adheres to regulatory requirements of, for instance, a European government agency, the environmental impact system 220 may generate data identifying the adherence of the supplier impact model 230 to the regulatory requirements, or other characteristics of the supplier model 230.

In the computing environment 200, the environmental impact system 220 provides one or more portions of the user account data 241 to the user device 250. Responsive to receiving the portions of the user account data 241, the user device 250 modifies a user interface, such as updating the user interface display 255. FIG. 2 depicts an example of a visual indicator on the user interface display 255, but other user interface techniques may be utilized, such as an audio interface, an interface including tactile indicators (e.g., vibration), or other types of user interfaces or indicators.

In some cases, the user device 250 receives the adjusted environmental impact factor 235a. In response to receiving the adjusted environmental impact factor 235a, the user device 250 updates the user interface display 255 to display (or otherwise provide) an adjusted environmental impact indicator 253. The adjusted environmental impact indicator 253 provides a visual indicator (or other suitable user interface indicator) of data included in the adjusted environmental impact factor 235a. In the example carbon impact factor, for instance, the adjusted environmental impact indicator 253 could display a measurement value of carbon emissions involved in the activity-source combination described by the event data 210. In some embodiments, the user device 250 can modify or generate the adjusted environmental impact indicator 253 based on additional portions of the user account data 241. For example, the user interface display 255 may indicate one or more of the environmental impact factor 235, the user-specific modifier 245, or one or more of the impact context factors 243. In some cases, providing indicators describing the adjusted environmental impact factor 235a or factors that modify the environmental impact factor 235 may provide beneficial information to the person utilizing the user device 250, such as information that enables the person to make educated choices about activities that can reduce an environmental impact of the person (e.g., walking to restaurants).

In addition, the user device 250 receives the cumulative impact data 249. In response to receiving the cumulative impact data 249, the user device 250 updates the user interface display 255 to display (or otherwise provide) a cumulative impact indicator 259. The cumulative impact indicator 259 provides a visual indicator (or other suitable user interface indicator) of data included in the cumulative impact data 249. In the example carbon impact factor, for instance, the cumulative impact indicator 259 could display measurements of cumulative carbon emissions, such as during a historical time period. In some cases, the cumulative impact indicator 259 could display a projected cumulative impact, such as estimated measurements of extrapolated carbon emissions for a future time period. In some embodiments, the user device 250 can modify or generate the cumulative impact indicator 259 based on additional portions of the user account data 241. For example, the user interface display 255 may indicate the environmental impact threshold data 247, such as by providing an indication of whether the cumulative impact data 249 exceeds or is within the threshold value. In some cases, providing indicators describing the cumulative impact data 249 or the environmental impact threshold data 247 may provide beneficial information to the person utilizing the user device 250, such as information that enables the person to identify activities that can reduce a cumulative environmental impact (or projected impact) of the person. In some cases, the user interface display may indicate information utilized in calculating the user-specific modifier 245 or the adjusted environmental impact factor 235a, such as data describing characteristics of the supplier model 230, the user impact model 240, the impact context factors 243, data collections, or other information utilized by the environmental impact system 220.

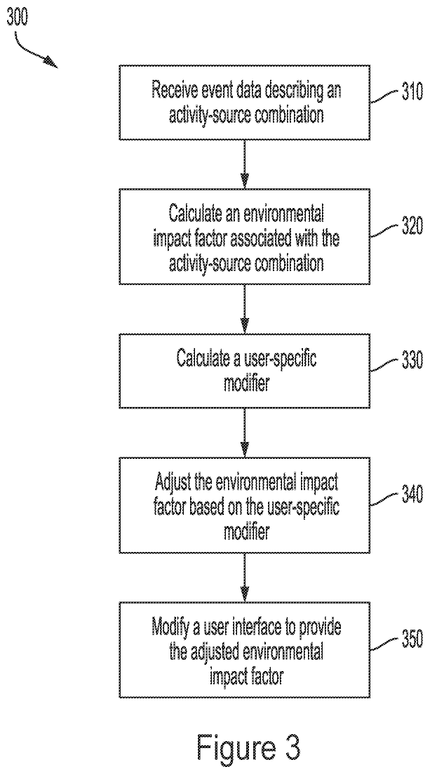

FIG. 3 is a flow chart depicting an example of a process 300 for providing, via a user interface, a user-adjusted environmental impact factor that is based on a combination of data outputs from multiple computer-implemented models. In some embodiments, such as described in regards to FIGS. 1-2, a computing device executing an environmental impact system implements operations described in FIG. 3, by executing suitable program code. For illustrative purposes, the process 300 is described with reference to the examples depicted in FIGS. 1-2. Other implementations, however, are possible.

At block 310, the process 300 involves receiving event data, such as event data that describes an activity-source combination. In some cases, the event data is associated with a user account, such as a user account for a user device or a person who utilizes the user device. For example, an environmental impact system could receive the event data from a computing system that handles activity data that is associated with one or more user accounts. The environmental impact system 120, for instance, receives the event data 110 from the event data repository 105. In addition, the environmental impact system 220 receive the event data 210 that is associated with the user account of the user device 250. In some cases, the environmental impact system identifies the activity-source combination based on the received event data. For example, the environmental impact system 220 identifies an activity-source combination that is described by the event data 210.

At block 320, the process 300 involves calculating an environmental impact factor associated with at least a portion of the event data, such as the activity-source combination described by the event data. In some cases, a supplier impact model included in (or otherwise in communication with) the environmental impact system calculates the environmental impact factor based on data describing allocated resources or supply chain involvement (or both) that are correlated with the activity-source combination. For example, the supplier impact model 230 calculates the environmental impact factor 235 that describes an environmental impact of the activity-source combination from the event data 210. In some cases, the environmental impact factor 235 is calculated based on the event data 210 and additional data describing an environmental impact of resources and supply chains involved in the activity-source combination from the event data 210.

At block 330, the process 300 involves calculating a user-specific modifier, such as a user-specific modifier that is associated with the activity-source combination described by the event data. For example, the user-specific modifier could be associated with the user account for the event data. In some cases, a user impact model included in (or otherwise in communication with) the environmental impact system calculates the user-specific modifier based on one or more impact context factors, such as impact context factors associated with the user account for the event data. For example, the user impact model 240 calculates the adjusted environmental impact factor 235a based on a combination of the environmental impact factor 235 and one or more of the impact context factors 243. In some embodiments, the user-specific modifier describes one or more characteristics associated with the user account (e.g., characteristics of a person utilizing the user account) that modify the environmental impact of the activity-source combination described by the event data. Examples of characteristics that could modify an environmental impact include a preference for walking, utilization of renewable sources of energy, a preference for a plant-based diet, or other characteristics that could modify an environmental impact.

At block 340, the process 300 involves adjusting the environmental impact factor based on the user-specific modifier. In some cases, the environmental impact system can adjust the environmental impact factor to indicate a higher or lower environmental impact based on the user-specific modifier. For example, the environmental impact system 220 generates the adjusted environmental impact factor 235a based on the environmental impact factor 235 and the user-specific modifier 245. In some cases, the adjusted environmental impact factor describes a modification to the environmental impact factor related to the activity-source combination, based on the impact context factors associated with the user account. As an example, if the user-specific modifier indicates relatively low consumption of gasoline (e.g., based on an impact context factor indicating a preference for walking), the environmental impact system could adjust the environmental impact factor to indicate a relatively lower environmental impact. As an additional example, if the user-specific modifier indicates relatively high consumption of gasoline (e.g., based on an impact context factor indicating a vehicle with low fuel efficiency), the environmental impact system could adjust the environmental impact factor to indicate a relatively higher environmental impact.

At block 350, the process 300 involves modifying a user interface to provide the adjusted environmental factor. In some cases, the user device that is associated with the user account receives from the environmental impact system data describing the adjusted environmental impact factor. In addition, the user device modifies a user interface responsive to receiving the data. For example, responsive to receiving data describing the adjusted environmental impact factor 235a from the environmental impact system 220, the user device 250 modifies the user interface display 255. The modified user interface display 255 can display the adjusted environmental impact indicator 253 describing the adjusted environmental impact factor 235a. In some cases, the user interface is modified responsive to additional data provided by the environmental impact system, such as to provide indications of a threshold value or cumulative impact data for an environmental impact. For example, the user device 250 can update the user interface display 255 responsive to receiving one or more of the environmental impact threshold data 247 or the cumulative impact data 249.

In some embodiments, operations related to one or more blocks of the process 300 are repeated, such as for multiple event data or for multiple portions of the event data. For example, if the received event data describes an activity that includes multiple items, such as multiple grocery items included in a particular purchase transaction, the environmental impact system could calculate multiple environmental impact factors for respective activity-source combinations associated with respective grocery items.

In some embodiments, an environmental impact system is configured to identify an event characteristic that could reduce an environmental impact of additional events. In addition, the environmental impact system can provide data to a user device describing the identified characteristic. Responsive to receiving the data describing the identified characteristic, the user device can update a user interface display to indicate the identified characteristic. In some cases, providing information about identified characteristics can inform a person utilizing the user device about possible event modifications that can reduce the person's environmental impact.

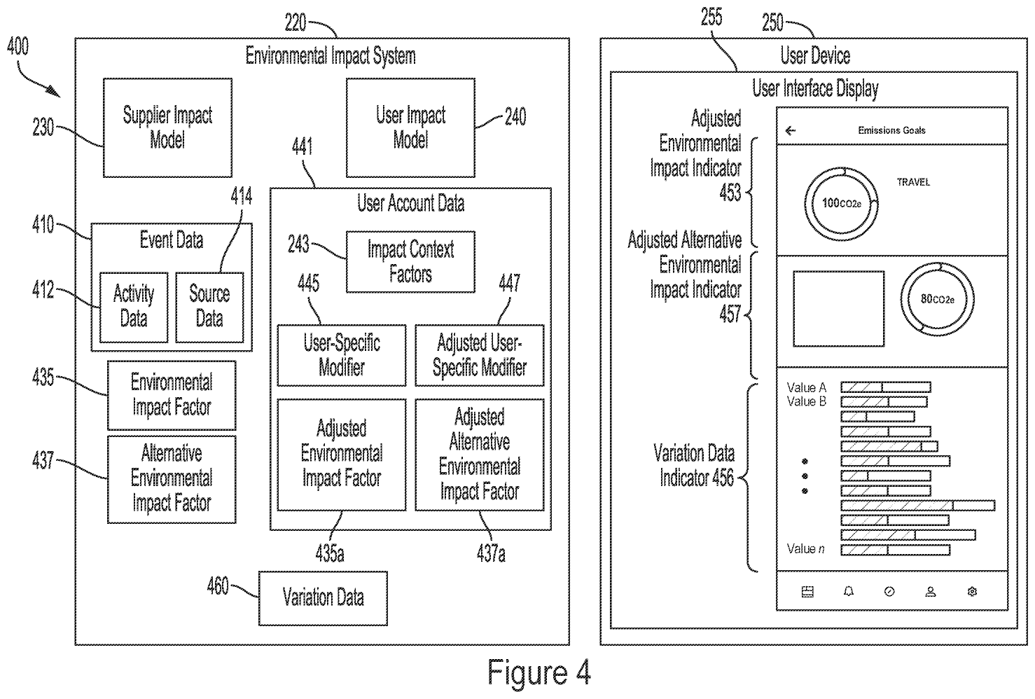

FIG. 4 is a diagram depicting an example of a computing environment 400 in which an environmental impact system, such as the environmental impact system 220, is configured for identifying one or more characteristics of an event that can modify an impact of the event. The computing environment 400 includes the environmental impact system 220 and the user device 250, such as generally described in regards to FIG. 2.

In the computing environment 400, the environmental impact system 220 receives additional event data, such as event data 410. The event data 410 can be received from a third-party computing system that handles transactions or other activities associated with user accounts, as generally described in regard to FIG. 1. In FIG. 4, the event data 410 includes data describing at least one event that is associated with the user account of the user device 250. Based on the event data 410, the environmental impact system 220 identifies one or more activity-source combinations associated with the user account of the user device 250. In some cases, the environmental impact system 220 identifies, from the event data 410, activity data 412 and source data 414. As an example, the event data 410 could describe a purchase transaction that is performed via a financial account associated with the user device 250. In addition, the environmental impact system 220 could determine that the example purchase transaction indicates a combination of an activity described by the activity data 412, such as purchasing a cheeseburger, and a source described by the source data 414, such as a restaurant that prepared the cheeseburger. In some cases, the environmental impact system 220 identifies that the combination of the activity data 412 and the source data 414 describes at least one activity-source combination described by the event data 410.

In FIG. 4, the environmental impact system 220 generates one or more of an environmental impact factor 435 or an adjusted environmental impact factor 435a. For example, the supplier impact model 230 receives one or more of the event data 410 or data describing the identified activity-source combination, such as the activity data 412 or the source data 414. The supplier impact model 230 generates the environmental impact factor 435 by calculating an environmental impact of the activity-source combination, such as a carbon impact calculated based on allocated resources and/or supply chain involvement for the example of the cheeseburger prepared by the restaurant. In some cases, the user impact model 240 generates a user-specific modifier 445. In some cases, the user-specific modifier 445 could be associated with the activity-source combination described by the event data 410. In addition, the user-specific modifier 445 could be calculated based on one or more of the impact context factors 243. The environmental impact system 220 generates the adjusted environmental impact factor 435a based on a combination of the environmental impact factor 435 output by the supplier impact model 230 and the user-specific modifier 445 output by the user impact model 240.

In the computing environment 400, the environmental impact system 220 includes (or otherwise is configured to access) variation data 460. The variation data 460 includes, for example, one or more values for at least one characteristic of the activity-source combination described by the event data 410. For instance, the variation data 460 could include data describing values for one or more characteristics of the activity data 412. In addition, the variation data 460 could include data describing values for one or more characteristics of the source data 414. In some cases, the variation data 460 can describe characteristics that are variations of the activity-source combination described by the event data 410. In the above example of the cheeseburger prepared by the restaurant, for instance, the variation data 460 could include a first data value describing a variation for a “protein” characteristic of the activity data 412, such as data values describing “beef,” “plant-based,” or “seafood” characteristic variations. Continuing with this example, the variation data 460 could include a second data value describing a variation for a “location” characteristic of the source data 414, such as data values describing addresses for multiple locations of the restaurant or additional restaurants.

Based on the variation data 460, the environmental impact system 220 generates one or more of an alternative environmental impact factor 437 or an adjusted alternative environmental impact factor 437a. For example, the environmental impact system 220 identifies one or more characteristics of the event data 410, such as a characteristic of the activity data 412 or a characteristic of the source data 414. In some cases, the environmental impact system 220 provides data describing the identified characteristics to the supplier impact model 230. Based on the characteristic data, the event data 410, or a combination of the characteristic data and the event data 410, the supplier impact model 230 generates the alternative environmental impact factor 437 by calculating an environmental impact for a variation of the activity-source combination indicated by the event data 410. For example, the supplier impact model 230 could modify the activity data 412 or the source data 414 based on the characteristic data, and calculate the alternative environmental impact factor 437 based on a combination of the modified activity data 412 and the modified source data 414. In addition, the user impact model 240 generates an additional user-specific modifier 447. The adjusted user-specific modifier 447 could be calculated, for example, based on the alternative environmental impact factor 437 and one or more of the impact context factors 243. In some cases, the adjusted user-specific modifier 447 could include data that is identical, or substantially identical, to the user-specific modifier 445. In addition, the adjusted user-specific modifier 447 could include data that is different from the user-specific modifier 445. For example, if the environmental impact system 220 identifies a location characteristic of the source data 414 that describes a restaurant that is within walking distance (e.g., of a location for the user device 250), the adjusted user-specific modifier 447 could indicate a reduced carbon impact related to the location variation of the activity-source combination indicated by the event data 410. In FIG. 4, the factors 435, 435a, 437, and 437a are described as indicating a carbon impact, but other types of impact factors are possible.

In some cases, the environmental impact system 220 determines recommendation data that is associated with one or more environmental impact factors. For example, the environmental impact system 220 can determine recommendation data that is associated with the particular activity-source combination described by the alternative environmental impact factor 437. In some cases, the recommendation data can include (or otherwise correspond to) incentive data associated with the particular activity-source combination described by the alternative environmental impact factor 437. For example, the environmental impact system 220 could determine recommendation data that describes a discount, a donation (e.g., to a non-profit organization), a rebate, or another type of recommendation or incentive associated with the particular activity-source combination. In some cases, the environmental impact system 220 could access the recommendation data via an additional computing system, such as a third-party computing system that recommendation or incentive data associated with one or more activity-source combinations. In addition, the environmental impact system 220 could access the recommendation data via a component of the environmental impact system 220, such as a database included in the system 220.

In some embodiments, the environmental impact system 220 generates or modifies a portion of user account data 441 based on data outputs from one or more of the supplier impact model 230 or the user impact model 240. The user account data 441 can include at least one data object that is associated with the user account for the user device 250. In some cases, the user account data 441 is included in, or modified from, the user account data 241 described in regard to FIG. 2. The environmental impact system 220 can modify the user account data 441 to include the impact context factors 243. In addition, the environmental impact system 220 can modify the user account data 441 to include one or more of the user-specific modifier 445, the adjusted user-specific modifier 447, the adjusted environmental impact factor 435a, or the adjusted alternative environmental impact factor 437a. In some cases, the user account data 441 could include one or more of the environmental impact factor 435 or the alternative environmental impact factor 437. In addition, the environmental impact system 220 could modify the user account data 441 to include recommendation data associated with one or more of the adjusted environmental impact factor 435a or the adjusted alternative environmental impact factor 437a.

In FIG. 4, the environmental impact system 220 provides one or more portions of the user account data 441 to the user device 250. Responsive to receiving the portions of the user account data 441, the user device 250 modifies a user interface, such as updating the user interface display 255. In some cases, the user device 250 receives one or more of the adjusted environmental impact factor 435a or the adjusted alternative environmental impact factor 437a. In response to receiving the adjusted environmental impact factor 435a, the user device 250 updates the user interface display 255 to display (or otherwise provide) an adjusted environmental impact indicator 453. The adjusted environmental impact indicator 453 provides a visual indicator (or other suitable user interface indicator) of data included in the adjusted environmental impact factor 435a. In response to receiving the adjusted alternative environmental impact factor 437a, the user device 250 updates the user interface display 255 to display (or otherwise provide) an adjusted alternative environmental impact indicator 457. The adjusted alternative environmental impact indicator 457 provides a visual indicator (or other suitable user interface indicator) of data included in the adjusted alternative environmental impact factor 437a. In some cases, the user device 250 updates the user interface display 255 to provide a comparison indicator, describing a comparison between the factors 435a and 437a. For example, one or more of the indicators 453 or 457 could indicate a difference between respective environmental impacts of the adjusted environmental impact factor 435a and the adjusted alternative environmental impact factor 437a, such as an indication that characteristic variations associated with adjusted alternative environmental impact factor 437a can reduce a carbon impact of the activity-source combination described by the event data 410.

In some embodiments, the user device 250 updates the user interface display 255 responsive to additional data received from the environmental impact system 220. For example, the environmental impact system 220 can identify one or more additional values for characteristics of the event data 410. In addition, the environmental impact system 220 could generate one or more additional alternative environmental impact factors, or adjusted alternative environmental impact factors, for the additional characteristic values. In some cases, the environmental impact system 220 can provide to the user device 250 additional data describing one or more of the additional characteristic values, the additional alternative environmental impact factors, or the adjusted alternative environmental impact factors. Responsive to receiving the additional data, the user device 250 updates the user interface display 255 to display (or otherwise provide) a variation data indicator 456. The variation data indicator 456 provides a visual indicator (or other suitable user interface indicator) of multiple environmental impacts for the additional characteristic values. For example, the variation data indicator 456 can provide estimated impacts that are calculated based on the additional adjusted alternative environmental impact factors associated with the additional characteristic values, e.g., estimated impacts for example value A, example value B, and additional values through example value n. In some cases, the user device 250 modifies the user interface display 255 to display data describing a recommendation, such as recommendation data describing an activity-source combination with a relatively small environmental impact. For example, the user device 250 could update the user interface display 255 to display recommendation data for a minimum environmental impact among the adjusted environmental impact factor 435a, the adjusted alternative environmental impact factor 437a, and the characteristic values from the variation data 460. In some cases, the user device 250 could update the user interface display 255 to display incentive data that is included in (or otherwise associated with) the recommendation data, such as incentive data describing a discount for an activity-source combination with the minimum environmental impact. In some cases, the person who utilizes the user device 250 could be prompted to reduce an individual environmental impact based on the recommendation data, such as by acting on the incentive data for the activity-source combination with the minimum environmental impact.

In some embodiments, the user device 250 could update the user interface display 255 to indicate a comparison of one or more portions of the user account data 441 with one or more additional portions of additional user account data. For example, the environmental impact system 220 could determine that the user account data 441 is included in (or otherwise associated with) a group of user accounts. The group of user accounts could be associated with a geographical region, a personal connection (e.g., family member, friends via social media), an impact context factor (e.g., multiple user accounts having an impact context factor that indicates a preference for walking), or other characteristics indicated by user account data. In some cases, the environmental impact system 220 could compare portions of user account data within the group of user accounts, such as comparing the adjusted environmental impact factor 435a and additional adjusted environmental impact factors of additional user account data in the group. In addition, the environmental impact system 220 could provide to the user device 250 comparison data describing the comparison of the portions of user account data, such as between the adjusted environmental impact factor 435a and the additional adjusted environmental impact factors. In some cases, the environmental impact system 220 could determine comparison data in real-time, such as in response to additional event data describing additional activities associated with user accounts. In addition, the environmental impact system 220 could provide the real-time comparison data to the user device 250 or additional user devices associated with the group of user accounts.

Responsive to receiving the comparison data, the user device 250 could update the user interface display 255 to display (or otherwise indicate) the comparison data. An example of comparison data indicated via the user interface display 255 could include a relative increase or decrease in the adjusted environmental impact factor 435a (or other portions of the user account data 441) as compared to the additional adjusted environmental impact factors. An additional example of comparison data indicated via the user interface display 255 could include an aggregated value for environmental impact, such as cumulative impact data aggregated across all user account data in the group of user accounts. In some cases, the environmental impact system 220 could determine comparison data that compares the group of user account to additional groups of user accounts. In some embodiments, additional recommendation data could be included in each user account data in the group of user accounts, such as additional recommendation data describing an incentive for a particular user account within the group (e.g., intra-group comparison) or for each user account within the group (e.g., multi-group comparison). In some cases, the person who utilizes the user device 250 could be prompted to reduce an individual environmental impact based on the comparison data, such as by acting to minimize environmental impact within a particular group of user accounts.

In FIG. 4, the user device 250 updates the user interface display 255 responsive to a combination of data received from the environmental impact system 220. For example, one or more of the user device 250 or the environmental impact system 220 can determine a combination of characteristic value data from the variation data 460 with the environmental impact threshold data 247, the cumulative impact data 249, or additional data generated (or otherwise received) by the environmental impact system 220. As an example, the environmental impact system 220 could determine a combination of the cumulative impact data 249 with one or more characteristic values from the variation data 460, such as respective estimated modifications to the cumulative impact data 249 for each of the respective characteristic values. Responsive to receiving data describing the combination of the cumulative impact data 249 with the characteristic values, the user device 250 may update the user interface display 255 to indicate the respective estimated modifications, such as a modification to the variation data indicator 456. As an additional example, the user device 250 could determine a combination of the environmental impact threshold data 247 with one or more characteristic values from the variation data 460, such as by comparing the threshold data 247 with each of the respective characteristic values. Based on the combination of the environmental impact threshold data 247 with the characteristic values, the user device 250 may update the user interface display 255 to indicate the respective comparisons, such as indicating a particular value that contributes a relatively small impact towards the threshold data 247 or indicating one or more values that would result in exceeding the threshold data 247.

In some cases, providing indicators describing the adjusted environmental impact factor 435a, adjusted alternative environmental impact factor 437a, or characteristics from the variation data 460 may provide beneficial information to the person utilizing the user device 250, such as information that enables the person to plan additional activities, or variations of activities, that can reduce an environmental impact of the person. As an example, a person who desires to reduce an individual environmental impact can beneficially receive accurate and convenient information about multiple activities having various user-adjusted environmental impacts, such as various options described by respective adjusted alternative environmental impact factors. In addition, the respective adjusted alternative environmental impact factors can assist the example person in understanding multiple collections of complex data, such as data collections that describe activities, sources, resource allocation, or supply chains. For instance, the respective adjusted alternative environmental impact factors may provide the person with beneficial information about relative environmental impacts of activities, such as relative impacts of organic produce that is shipped a long way as compared to non-organic produce that is shipped from a closer location. In some cases, the example person may be able to more effectively reduce an individual environmental impact based on the respective adjusted alternative environmental impact factors, as compared to attempting to reduce an impact based on a naïve understanding of the multiple collections of complex data.

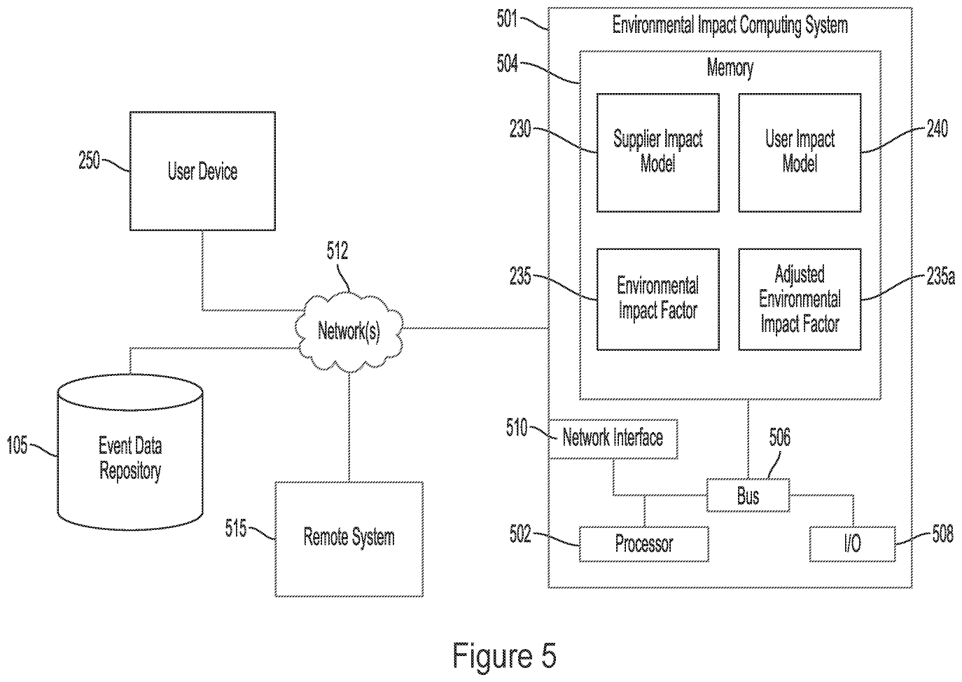

Any suitable computing system or group of computing systems can be used for performing the operations described herein. For example, FIG. 5 is a block diagram depicting an environmental impact computing system 501 that is configured to perform one or more techniques described in regard to FIGS. 1-4, according to certain embodiments.

The depicted example of the environmental impact computing system 501 includes one or more processors 502 communicatively coupled to one or more memory devices 504. The processor 502 executes computer-executable program code or accesses information stored in the memory device 504. Examples of processor 502 include a microprocessor, an application-specific integrated circuit (“ASIC”), a field-programmable gate array (“FPGA”), or other suitable processing device. The processor 502 can include any number of processing devices, including one.

The memory device 504 includes any suitable non-transitory computer-readable medium for storing the supplier impact model 230, the user impact model 240, the environmental impact factor 235, the adjusted environmental impact factor 235a, and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The environmental impact computing system 501 may also include a number of external or internal devices, such as input or output devices. For example, the environmental impact computing system 501 is shown with an input/output (“I/O”) interface 508 that can receive input from input devices or provide output to output devices. A bus 506 can also be included in the environmental impact computing system 501. The bus 506 can communicatively couple one or more components of the environmental impact computing system 501.

The environmental impact computing system 501 executes program code that configures the processor 502 to perform one or more of the operations described above with respect to FIGS. 1-4. The program code includes operations related to, for example, one or more of the supplier impact model 230, the user impact model 240, the environmental impact factor 235, the adjusted environmental impact factor 235a, or other suitable applications or memory structures that perform one or more operations described herein. The program code may be resident in the memory device 504 or any suitable computer-readable medium and may be executed by the processor 502 or any other suitable processor. In some embodiments, the program code described above, the supplier impact model 230, the user impact model 240, the environmental impact factor 235, and the adjusted environmental impact factor 235a are stored in the memory device 504, as depicted in FIG. 5. In additional or alternative embodiments, one or more of the supplier impact model 230, the user impact model 240, the environmental impact factor 235, the adjusted environmental impact factor 235a, and the program code described above are stored in one or more memory devices accessible via a data network, such as a memory device accessible via a cloud service.

The environmental impact computing system 501 depicted in FIG. 5 also includes at least one network interface 510. The network interface 510 includes any device or group of devices suitable for establishing a wired or wireless data connection to one or more data networks 512. Non-limiting examples of the network interface 510 include an Ethernet network adapter, a modem, and/or the like. A remote system 515 is connected to the environmental impact computing system 501 via network 512, and remote system 515 can perform some of the operations described herein, such as providing variation data or recommendation data. The environmental impact computing system 501 is able to communicate with one or more of the remote computing system 515, the user device 250, or the event data repository 105 using the network interface 510. Although FIG. 5 depicts the event data repository 105 as connected to environmental impact computing system 501 via the networks 512, other embodiments are possible, including the environmental impact computing system 501 storing event data in the memory 504, or receiving event data from the user device 250.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms, such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A system comprising:
a processor,
a network communications port controlled by the processor to communicate, via a data network, with a third-party system, and
a non-transitory computer-readable storage device storing instructions that are executable by the processor to:
receive, via the network communications port and from the third-party system, event data that is associated with a user account, the event data describing an activity-source combination;
calculate, via a supplier impact model, an environmental impact factor that describes resources that are allocated via the activity-source combination;
receive, by a user impact model, the environmental impact factor calculated by the supplier impact model and an impact context factor associated with the user account, wherein the impact context factor describes one or more characteristics associated with a user of the user account and the one or more characteristics includes at least one or a geographic location of the user, a transportation preference of the user, or a preferred diet of the user;
calculate, via the user impact model and based on the impact context factor, a user-specific modifier that describes an adjustment to the environmental impact factor;
generate an adjusted environmental impact factor based on a combination of the user-specific modifier received from the user impact model and the environmental impact factor received from the supplier impact model;
access environmental impact threshold data that is associated with the user account, wherein the environmental impact threshold data corresponds to a target value associated with the user account;
calculate, via the user impact model, a difference between the adjusted environmental impact factor and the environmental impact threshold data; and
modify, on a user device associated with the user account, a user interface display to display the adjusted environmental impact factor, the difference, and an indicator associated with the activity-source combination.

2. The system of claim 1, the instructions further executable to:
calculate, via the user impact model:
i) a projected cumulative environmental impact; and
modify the user interface display to display the projected cumulative environmental impact.

3. The system of claim 1, the instructions further executable to:
identify a characteristic of the activity-source combination, wherein the characteristic has two or more values describing respective variations of the activity-source combination;
calculate, via the supplier impact model, an alternative environmental impact factor associated with a particular variation of the activity-source combination;
adjust the alternative environmental impact factor based on the user-specific modifier; and
modify the user interface display to display the adjusted alternative environmental impact factor.

4. The system of claim 3, the instructions further executable to:
calculate a difference between the adjusted environmental impact factor and the adjusted alternative environmental impact factor; and
modify the user interface display to display the adjusted alternative environmental impact factor.

5. The system of claim 3, the instructions further executable to:
access recommendation data associated with the particular variation of the activity-source combination; and
modify the user interface display to display the recommendation data.

6. (canceled)

7. The system of claim 1, wherein the user-specific modifier is calculated based on at least one additional impact context factor.

8. A method of generating user-adjusted environmental impact data, the method including operations executed by a processor, the operations comprising:
receiving, from a third-party computing system, event data that is associated with a user account, the event data describing an activity-source combination;
calculating, via a supplier impact model, an environmental impact factor that describes resources that are allocated via the activity-source combination;
receiving, by a user impact model, the environmental impact factor calculated by the supplier impact model and an impact context factor associated with the user account, wherein the impact context factor describes one or more characteristics associated with a user of the user account and the one or more characteristics includes at least one or a geographic location of the user, a transportation preference of the user, or a preferred diet of the user;
calculating, via the user impact model and based on the impact context factor, a user-specific modifier that describes an adjustment to the environmental impact factor;
generating an adjusted environmental impact factor based on a combination of the user-specific modifier received from the user impact model and the environmental impact factor received from the supplier impact model;
accessing environmental impact threshold data that is associated with the user account, wherein the environmental impact threshold data corresponds to a target value associated with the user account;
calculating, via the user impact model, a difference between the adjusted environmental impact factor and the environmental impact threshold data; and
modifying, on a user device associated with the user account, a user interface display to display the adjusted environmental impact factor, the difference, and an indicator associated with the activity-source combination.

9. The method of claim 8, further comprising:
calculating, via the user impact model:
i) a projected cumulative environmental impact; and
modifying the user interface display to display the projected cumulative environmental impact.

10. The method of claim 8, further comprising:
identifying a characteristic of the activity-source combination, wherein the characteristic has two or more values describing respective variations of the activity-source combination;
calculating, via the supplier impact model, an alternative environmental impact factor associated with a particular variation of the activity-source combination;
adjusting the alternative environmental impact factor based on the user-specific modifier; and
modifying the user interface display to display the adjusted alternative environmental impact factor.

11. The method of claim 10, further comprising:
calculating a difference between the adjusted environmental impact factor and the adjusted alternative environmental impact factor; and
modifying the user interface display to display the adjusted alternative environmental impact factor.

12. The method of claim 10, further comprising:
accessing recommendation data associated with the particular variation of the activity-source combination; and
modifying the user interface display to display the recommendation data.

13. (canceled)

14. The method of claim 8, wherein the user-specific modifier is calculated based on at least one additional impact context factor.

15. A non-transitory computer-readable medium embodying program code for generating user-adjusted environmental impact data, wherein, when executed by a processor, the program code causes the processor to perform operations comprising:
receiving, from a third-party computing system, event data that is associated with a user account, the event data describing an activity-source combination;
calculating, via a supplier impact model, an environmental impact factor that describes resources that are allocated via the activity-source combination;
receiving, by a user impact model, the environmental impact factor calculated by the supplier impact model and an impact context factor associated with the user account, wherein the impact context factor describes one or more characteristics associated with a user of the user account and the one or more characteristics includes at least one or a geographic location of the user, a transportation preference of the user, or a preferred diet of the user;
calculating, via the user impact model and based on the impact context factor, a user-specific modifier that describes an adjustment to the environmental impact factor;
generating an adjusted environmental impact factor based on a combination of the user-specific modifier received from the user impact model and the environmental impact factor received from the supplier impact model;
accessing environmental impact threshold data that is associated with the user account, wherein the environmental impact threshold data corresponds to a target value associated with the user account;
calculating, via the user impact model, a difference between the adjusted environmental impact factor and the environmental impact threshold data; and
modifying, on a user device associated with the user account, a user interface display to display the adjusted environmental impact factor, the difference, and an indicator associated with the activity-source combination.

16. The non-transitory computer-readable medium of claim 15, wherein the program code causes the processor to perform operations further comprising:
calculating, via the user impact model:
i) a projected cumulative environmental impact; and
modifying the user interface display to display the difference and the projected cumulative environmental impact.

17. The non-transitory computer-readable medium of claim 15, wherein the program code causes the processor to perform operations further comprising:
identifying a characteristic of the activity-source combination, wherein the characteristic has two or more values describing respective variations of the activity-source combination;
calculating, via the supplier impact model, an alternative environmental impact factor associated with a particular variation of the activity-source combination;
adjusting the alternative environmental impact factor based on the user-specific modifier; and
modifying the user interface display to display the adjusted alternative environmental impact factor.

18. The non-transitory computer-readable medium of claim 17, wherein the program code causes the processor to perform operations further comprising:
calculating a difference between the adjusted environmental impact factor and the adjusted alternative environmental impact factor; and
modifying the user interface display to display the adjusted alternative environmental impact factor.

19. The non-transitory computer-readable medium of claim 17, wherein the program code causes the processor to perform operations further comprising:
accessing recommendation data associated with the particular variation of the activity-source combination; and
modifying the user interface display to display the recommendation data.

20. The non-transitory computer-readable medium of claim 15, wherein the user-specific modifier is calculated based on at least one additional impact context factor.
